(19) United States
(12) Patent Application Publication
(10) Pub. No.: US 2009/0310483 A1
(43) Pub. Date: Dec. 17, 2009

(54) NETWORK DEVICE AND LINK SWITCHING METHOD

(76) Inventor: SHUICHI OKAZAKI, Tokyo (JP)

Correspondence Address: Mr. Jackson Chen, 6535 N. STATE HWY 161, IRVING, TX, 75039, US

(21) Appl. No.: 12/482,652

(22) Filed: Jun. 11, 2009

(30) Foreign Application Priority Data
Jun. 17, 2008 (JP) 2008-157428

(51) Int. Cl. G06F 11/00

(52) U.S. Cl. 370/228

(57) ABSTRACT

A network device connecting a plurality of Ethernet links, includes: an Ethernet maintenance and administration section for periodically checking whether a link fault occurs on each Ethernet link; a link manager for updating link status information for each Ethernet link according to a check result of the Ethernet link; and a link switching processor for switching from a fault-detected Ethernet link to another Ethernet link according to link status information of the Ethernet links.

This application is based upon and claims the benefit of priority from Japanese Patent Application No. 2008-157428, filed on Jun. 17, 2008, the disclosure of which is incorporated herein in its entirety by reference.

### BACKGROUND OF THE INVENTION

1. Field of the Invention

The present invention relates to a communication network and, more particularly, to a network device having Ethernet maintenance and administration functionality, as well as a link switching method used in the same. Note that “Ethernet” is a registered trademark.

2. Description of the Related Art

Ethernet was originally created as a local area network (LAN) technology but, in recent years, has become used for wide area networks. However, Ethernet, which is standardized as a technology for LAN, is not provided with OAM (Operations, Administration and Maintenance) functionality that allows monitoring of the state of a remote network device, bypassing of a link fault, and the like.

TCP/IP-based simple network management protocol (SNMP) is used in many cases to maintain and administer an Ethernet network. In this case, however, when a remote network device has become unable to be managed with SNMP, it is impossible to determine whether the cause resides in the IP (Internet Protocol) layer or in the Ethernet network. Accordingly, for Ethernet, a function is needed that makes it possible to maintain and administer a remote network device, and the standardization of Ethernet OAM functionality has been pursued (see ITU-T recommendation Y.1731 and IEEE 802.1ag).

As well known, the main functions of Ethernet OAM are limited to those for fault detection and performance measurement such as delay measurement. For the fault detection functions, defined are the continuity check (CC) function, loop back (LB) test function, and link trace (LT) function. For example, a method for detecting a fault using the CC function is disclosed in Japanese Patent Application Unexamined Publication No. 2007-243466.

However, the functions of Ethernet OAM are confined in the scope of fault detection and performance monitoring, and operations after fault detection are not standardized. Therefore, recovery after fault detection depends on manual operations, which means that it takes much time to recover from a fault.

Regarding the detection of a network fault and the generation of a path bypassing the fault, for example, Japanese Patent Application Unexamined Publication No. 2002-016617 and others disclose techniques, which use a general wide area network technology in which an OAM cell is transmitted over an ATM network.

### SUMMARY OF THE INVENTION

An object of the present invention is to provide a network device and a link switching method by which high-speed link switching can be achieved through fault detection utilizing Ethernet OAM functionality.

According to the present invention, a network device connecting a plurality of Ethernet links, includes: an Ethernet maintenance and administration section for periodically checking whether a link fault occurs on each Ethernet link; a link manager for updating link status information for each Ethernet link according to a check result of the Ethernet link; and a link switching processor for switching from a fault-detected Ethernet link to another Ethernet link according to link status information of the Ethernet links.

According to the present invention, a method for switching Ethernet links in a network device connecting a plurality of Ethernet links, includes the steps of: periodically checking whether a link fault occurs on each Ethernet link; updating link status information for each Ethernet link according to a check result of the Ethernet link; and switching from a fault-detected Ethernet link to another Ethernet link according to link status information of the Ethernet links.

According to the present invention, high-speed link switching can be achieved through fault detection utilizing Ethernet OAM functionality.

### BRIEF DESCRIPTION OF THE DRAWINGS

FIG. 1 is a block diagram showing a basic functional configuration of a network device according to an exemplary embodiment of the present invention.

FIG. 2 is a block diagram showing a basic functional configuration of a router according to a first example of the present invention.

FIG. 3 is a diagram showing a network structure, to describe link switching operation according to the first example of the present invention.

FIG. 4 is a flowchart schematically showing the internal operation of each router that executes the link switching operation according to the first example.

FIG. 5 is a diagram showing a network structure, to describe link switching operation according to a second example of the present invention.

FIG. 6 is a block diagram showing a basic functional configuration of a router according to a third example of the present invention.

FIG. 7 is a diagram showing a network structure, to describe link switching operation according to the third example of the present invention.

### DETAILED DESCRIPTION OF THE PREFERRED EMBODIMENTS

### 1. EMBODIMENT

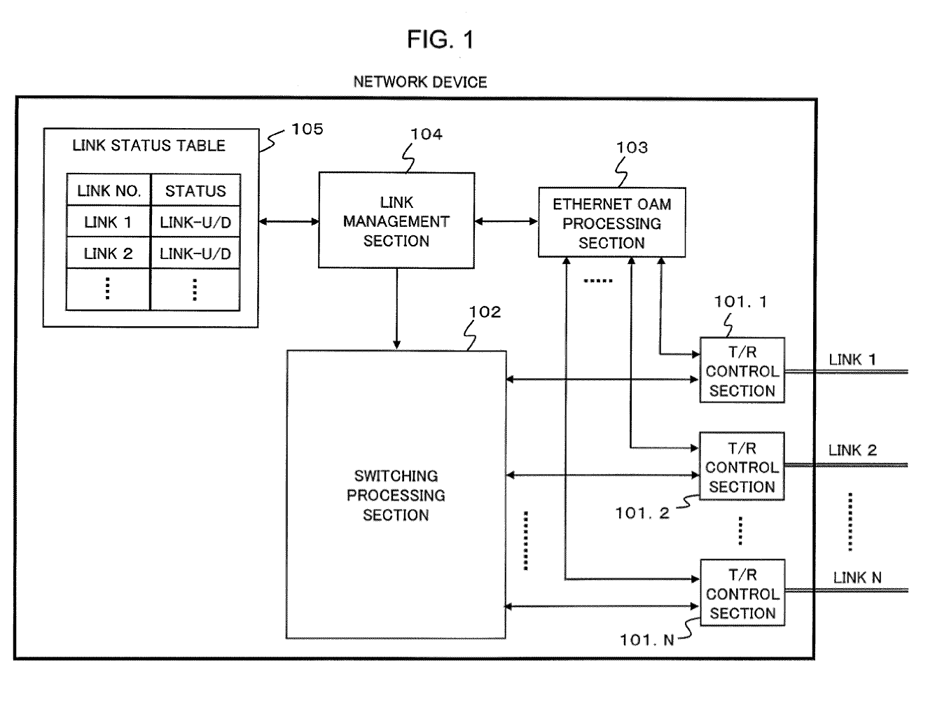

FIG. 1 is a block diagram showing a basic functional configuration of a network device according to an exemplary embodiment of the present invention. In the present exemplary embodiment, a network device having a function of switching between a plurality of Ethernet links will be illustrated as an example. In this disclosure, a network device is defined as a communication device connected to a network. Examples of the network device include user communication equipment, a router on a network, and the like.

Referring to FIG. 1, the network device is provided with a plurality of transmission/reception (T/R) control sections 101.1 to 101.N which are connected to a plurality of Ethernet links 1 to N, respectively, and individually execute processing prescribed by Ethernet. The transmission/reception control sections 101.1 to 101.N are connected to input/output ports of a switching processing section 102, respectively, and the switching processing section 102 executes link switching in accordance with link status information from a link management section 104, which will be described later.

The network device is further provided with an Ethernet OAM processing section 103 which can perform maintenance and administration of the links 1 to N through the respective transmission/reception control sections 101.1 to 101. N. Here, it is assumed that the continuity of each link is checked by utilizing the CC function of Ethernet OAM in such a manner that the network device in question and a network device on the other end of the link transmit a CC message (CCM) to each other at predetermined time intervals. Note that it is also possible to monitor each link by using the LB function or LT function.

The Ethernet OAM processing section 103 determines that a network fault has occurred between its own network device and a network device on the other end when receiving no CCM from the other-end network device even after a predetermined period of time has passed, and makes a notification to that effect to the link management section 104.

The link management section 104 receives fault detection information from the Ethernet OAM processing section 103 as input and performs link management using a link status table 105. The link status table 105 keeps the respective states (LINK-UP (LINK-U) or LINK-DOWN (LINK-D)) of the links 1 to N, which are updated based on the fault detection information from the Ethernet OAM processing section 103. Updated link status information is output from the link management section 104 to the switching processing section 102.

For example, upon receipt of a notification from the Ethernet OAM processing section 103 to the effect that a network fault has occurred in the link 1, the link management section 104 changes the state of the link 1 from LINK-U to LINK-D. At this time, if the backup link 2 is in LINK-DOWN state, the link management section 104 changes the state of the link 2 to LINK-UP. The thus updated link status information is output to the switching processing section 102. The switching processing section 102 switches the currently used link from the link 1 to the link 2 in accordance with the link status information, whereby a continuity check on the link 2 can be executed.

As mentioned below, a continuity check on the backup link 2 can also be performed independently of the state of the link 1. The Ethernet OAM processing section 103 can periodically transmit and receive a CCM to/from a network device on the other end of each link, irrespective of the link status in the link status table 105. Accordingly, it is possible to check the continuity of the backup link 2 in advance.

Additionally, the functions equivalent to the switching processing section 102, Ethernet OAM processing section 103, and link management section 104 can also be implemented with software by executing programs on a program-controlled processor such as a CPU (Central Processing Unit).

### 2. FIRST EXAMPLE

Hereinafter, a first example of the present invention will be described in more detail by taking a router as an example of the network device shown in FIG. 1.

### 2.1) Configuration

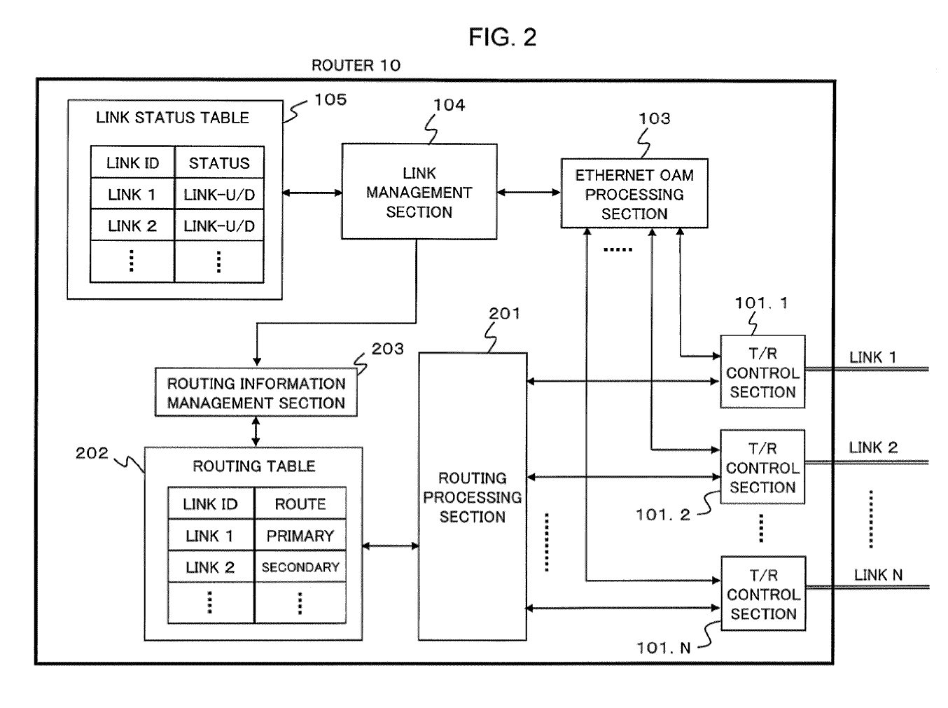

FIG. 2 is a block diagram showing a basic functional configuration of a router according to the first example of the present invention. Note that the blocks having the same functions as those of the network device shown in FIG. 1 are denoted by the same reference numerals as in FIG. 1 and a description thereof will be simplified.

In the router 10 according to the first example, the switching processing section 102 in FIG. 1 is composed of a routing processing section 201, a routing table 202, and a routing information management section 203. The routing processing section 201 has N input/output ports connected to the transmission/reception control sections 101.1 to 101.N, respectively, and executes routing of a transmission/reception signal in accordance with route information in the routing table 202.

The routing information management section 203 updates the routing table 202, based on the link status information from the link management section 104. For example, it is assumed that the link 1 is set as a primary route for communication with a network device on the other end. When a fault has occurred in the link 1, the link management section 104 updates the link status information, whereby the routing table 202 is updated, and thus the route can be switched to the link 2 set as a secondary route.

Incidentally, the functions equivalent to the Ethernet OAM processing section 103, link management section 104, routing processing section 201, and routing information management section 203 can also be implemented with software by executing programs on a program-controlled processor such as a CPU.

### 2.2) Operation

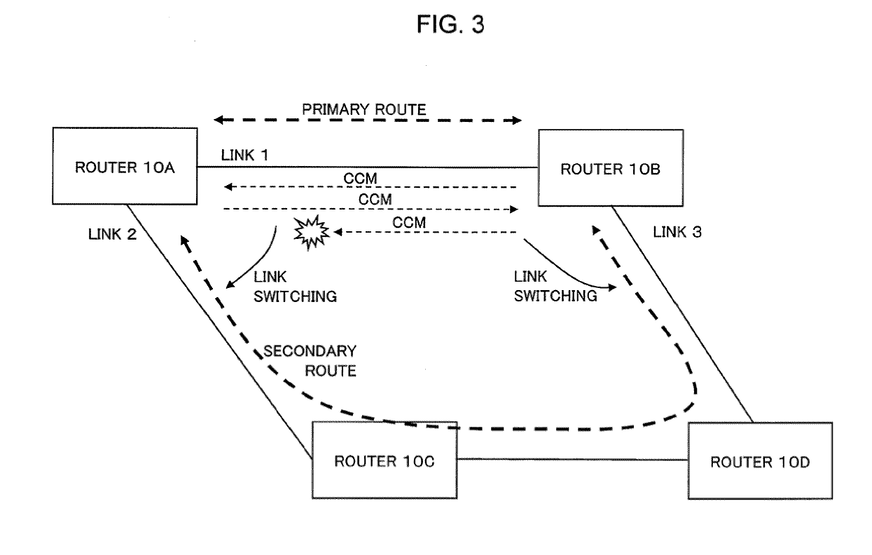

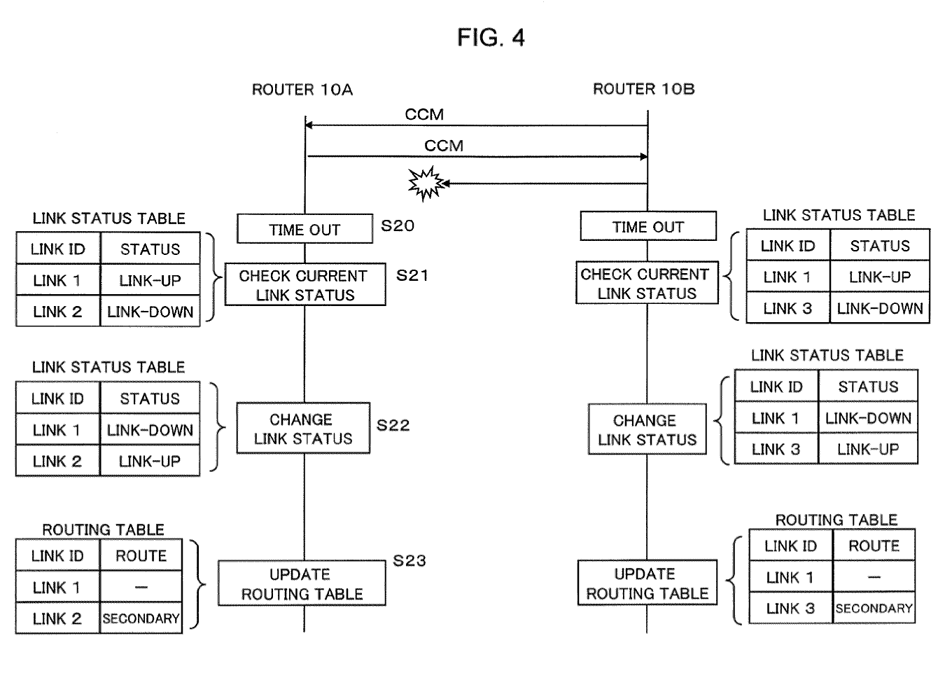

FIG. 3 is a diagram showing a network structure, to describe link switching operation according to the first example of the present invention. FIG. 4 is a flowchart schematically showing the internal operation of each router executing the link switching operation according to the first example.

To avoid complicating the description, here assumed is a network in which four routers 10A to 10D are connected in a ring shape as shown in FIG. 3, with a direct connection between the router 10A and the neighboring router 10B being a primary route, and a connection via the routers 10C and 10D being a secondary route.

The Ethernet OAM processing section 103 of the router 10A transmits a CCM at predetermined time intervals from the transmission/reception control section 101.1 to the router 10B, which is the other end of the link 1, and also receives a CCM from the router 10B at predetermined time intervals. The primary route using the link 1 operates normally as long as a CCM is normally received at the predetermined time intervals.

As shown in FIG. 4, when the Ethernet OAM processing section 103 of the router 10A does not receive a CCM from the router 10B even after a predetermined period of time has passed, a timeout occurs on a timer of the Ethernet OAM processing section 103 of the router 10A, whereby it is detected that a fault has occurred in the link 1 to the router 10B (Step 20).

The link management section 104 notified of the occurrence of a fault checks the current link status by referring to the link status table 105 (Step S21). Here, it is assumed that the link 1 is in LINK-UP state and the link 2 is in LINK-DOWN state as shown in FIG. 4. Subsequently, the link management section 104 updates the link status table 105, according to the notification of the occurrence of a fault in the link 1 (Step S22). Here, the state of the link 1 is changed from LINK-UP to LINK-DOWN, and the state of the link 2 is changed from LINK-DOWN to LINK-UP as shown in FIG. 4. The thus updated link status information is output to the routing information management section 203.

The routing information management section 203 updates the routing table 202 in accordance with the updated link status information (Step S23). Here, since the link 1, the primary route, is in LINK-DOWN state and the link 2, the secondary route, is in LINK-UP state, the routing table 202 is updated so that the transmission and reception of a signal to/from the router 10B will be performed through the secondary route. Similar switching is also made at the router 10B. Accordingly, at the router 10A, the currently used link to the router 10B is switched from the link 1 to the link 2, and at the router 10B, the currently used link to the router 10A is switched from the link 1 to the link 3. Resultantly, the connection between the routers 10A and 10B is switched from the primary route to the secondary route as shown in FIG. 3.

### 2.3) Effects

As described above, according to the first example of the present invention, high-speed link switching can be achieved through fault detection utilizing Ethernet OAM. In other words, it is possible to carry out an instantaneous update of the routing table 202 by performing fault detection on the layer 2, and it is thus possible to provide a high-speed backup.

### 3. SECOND EXAMPLE

A router 10 according to a second example of the present invention has a functional configuration similar to the router according to the first example shown in FIG. 2. However, the Ethernet OAM processing section 103 according to the second example can perform fault monitoring not only on the primary route but also on the secondary route. Specifically, fault monitoring is performed by periodically transmitting and receiving a CCM to/from a network device on the other end, as in the case of the primary route.

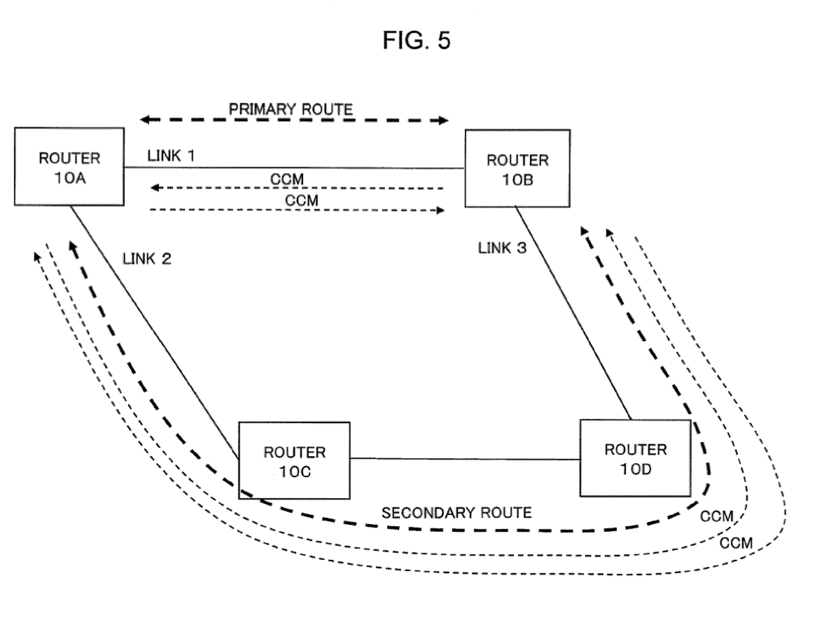

FIG. 5 is a diagram showing a network structure, to describe link switching operation according to the second example of the present invention. Assuming a network in which four routers 10A to 10D are connected in a ring shape as in the first example shown in FIG. 3, the router 10A monitors whether the reception of a CCM is normally performed over the primary route to the neighboring router 10B, and also concurrently monitors the reception of a CCM over the secondary route via the routers 10C and 10D in a similar manner.

As described above, a continuity check is performed also on the secondary route, whereby, when a network fault in the primary route is detected, it is possible to promptly secure the secondary route into which the communication should be diverted, and it is thus possible to achieve high-speed switching.

Moreover, even after switching to the secondary route is made, a continuity check on the primary route is continued. When the primary route has recovered, the link management section 104 updates the link status table 105, whereby it is possible to switch again from the secondary route to the original primary route.

### 4. THIRD EXAMPLE

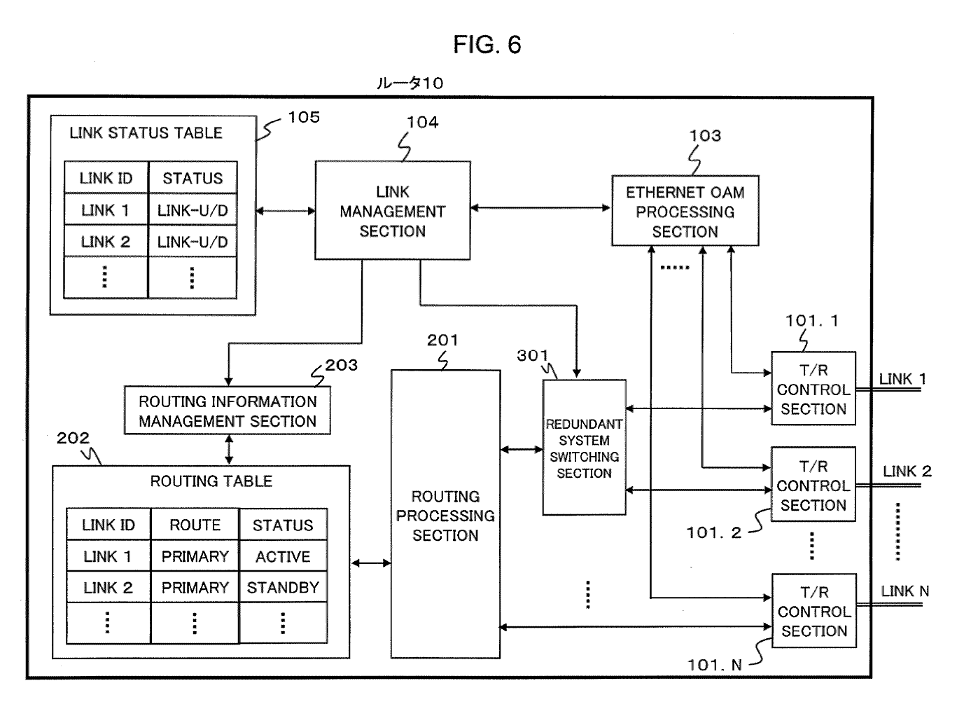

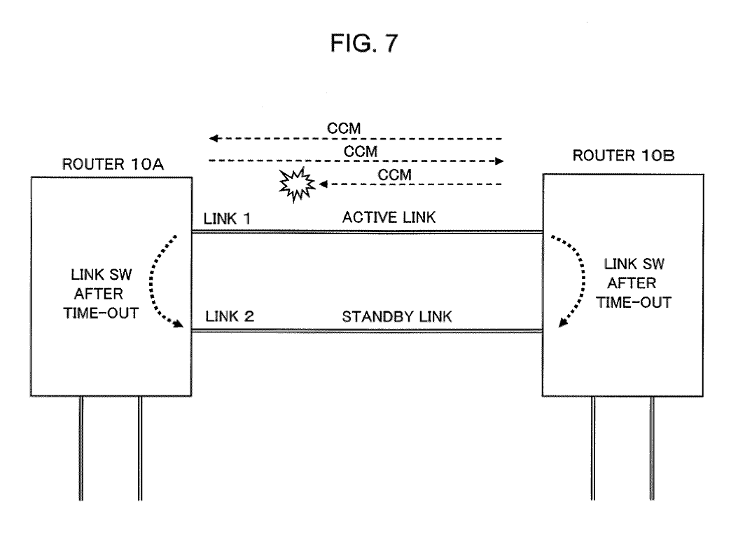

According to the present invention, it is also possible to make an Ethernet link between routers redundant. Hereinafter, a router and a network using a redundant system will be described with reference to FIGS. 6 and 7.

### 4.1) Configuration

FIG. 6 is a block diagram showing a basic functional configuration of a router according to a third example of the present invention. Note that the blocks having the same functions as those of the router shown in FIG. 2 are denoted by the same reference numerals as in FIG. 2 and a description thereof will be simplified. According to the third example, the transmission/reception control sections 101.1 and 101.2 connected to the links 1 and 2 respectively are connected to a redundant system switching section 301, and any one of the transmission/reception control sections 101.1 and 101.2 selected in accordance with a switching signal from the link management section 104 is connected to a single input/output port of the routing processing section 201. Here, it is assumed that the link 1 is an active (currently used) link and the link 2 is a standby link.

The routing information management section 203 updates the routing table 202 in accordance with the link status information from the link management section 104, as described in the first example. However, apart from the route information, link status about the redundant system is also stored in the routing table 202 according to the third example. Here, it is assumed that the link 1 is set as an active link and the link 2 is set as a standby link.

When a fault has occurred in the link 1, which is being used as an active link, the link management section 104 updates the link status information, thereby switching the redundant system switching section 301 from the link 1 to the link 2. Moreover, the routing table 202 is updated as described above, whereby the active link is switched from the link 1 to the link 2.

### 4.2) Operation

FIG. 7 is a diagram showing a network structure, to describe link switching operation according to the third example of the present invention. To avoid complicating the description, it is assumed that the network has a redundant structure in which the routers 10A and 10B are connected through two Ethernet links 1 and 2, with the link 1 set as an active link, and the link 2 set as a standby link, as described above.

The Ethernet OAM processing section 103 of the router 10A transmits a CCM at predetermined time intervals from the transmission/reception control section 101.1 to the router 10B on the other end of the link 1, and also receives a CCM from the router 10B at predetermined time intervals. The active link 1 operates normally as long as a CCM is normally received at the predetermined time intervals.

When the Ethernet OAM processing section 103 of the router 10A does not receive a CCM from the router 10B even after a predetermined period of time has passed as shown in FIG. 7, a timeout occurs on the timer of the Ethernet OAM processing section 103 of the router 10A, whereby it is detected that a fault has occurred in the link 1 to the router 10B.

The link management section 104 notified of the occurrence of a fault checks the current link status by referring to the link status table 105. Here, it is assumed that the link 1 is in LINK-UP state and the link 2 is in LINK-DOWN state. Subsequently, the link management section 104 updates the link status table 105, according to the notification of the occurrence of a fault in the link 1, switches the redundant system switching section 301 from the link 1 to the link 2, and outputs the updated link status information to the routing information management section 203.

The routing information management section 203 updates the routing table 202 in accordance with the updated link status information. Here, since the link 1 is in LINK-DOWN state and the link 2 is in LINK-UP state, the routing table 202 is updated so that the transmission and reception of a signal to/from the router 10B will be performed through the link 2. The switching of the redundant system switching section 301 from the link 1 to the link 2 and the update of the routing table 202 are also performed at the router 10B similarly. Thus, at the router 10A, the connection to the router 10B is switched from the link 1 to the link 2.

### 4.3) Effects

As described above, according to the third example of the present invention, even in a network where a plurality of Ethernet links are made redundant, high-speed protection can be realized through fault detection utilizing Ethernet OAM. Thus, it is possible to enhance the reliability of communication.

The present invention, which makes it possible to detect a fault in a link to a remote network device and to recover from the fault, can be applied to the networks of carriers and Internet providers, as well as private networks. Moreover, owing to the characteristics of Ethernet OAM, monitoring can be performed in domain units, with a network divided into a plurality of domains. Therefore, the present invention can also be applied to each of the plurality of divided domains, such as between customer devices, between edge routers, or between core routers.

The present invention may be embodied in other specific forms without departing from the spirit or essential characteristics thereof. The above-described exemplary embodiment and examples are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A network device connecting a plurality of Ethernet links, comprising:
an Ethernet maintenance and administration section for periodically checking whether a link fault occurs on each Ethernet link;
a link manager for updating link status information for each Ethernet link according to a check result of the Ethernet link; and
a link switching processor for switching from a fault-detected Ethernet link to another Ethernet link according to link status information of the Ethernet links.

2. The network device according to claim 1, wherein the link switching processor comprises:
a routing table which is updated according to the link status information; and
a routing processor for performing link switching by referring to the routing table.

3. The network device according to claim 1, wherein the Ethernet maintenance and administration section monitors both of a first Ethernet link which is a normally used link and a second Ethernet link which is a secondary link, wherein when a fault is detected in the first Ethernet link, the link switching processor switches a currently used link from the first Ethernet link to the second Ethernet link.

4. The network device according to claim 3, wherein the link switching processor comprises:
a routing table which is updated according to the link status information, wherein the a first Ethernet link is determined to be a normally used link and a second Ethernet link to be a secondary link in the routing table; and
a routing processor for performing link switching by referring to the routing table,
wherein the Ethernet maintenance and administration section monitors both of the first Ethernet link and the second Ethernet link, wherein when a fault is detected in the first Ethernet link, the link switching processor switches a currently used link from the first Ethernet link to the second Ethernet link.

5. The network device according to claim 3, wherein when the first Ethernet link has recovered, the link switching processor switches a currently used link from the second Ethernet link to the first Ethernet link.

6. The network device according to claim 4, wherein when the first Ethernet link has recovered, the link switching processor switches a currently used link from the second Ethernet link to the first Ethernet link.

7. The network device according to claim 1, further comprising a redundancy-system switch for connecting the link switching processor to a selected one of a plurality of redundant Ethernet links which are connected to a same node, wherein when a fault is detected in a currently used one of the redundant Ethernet links, the redundancy-system switch switches the currently used link to another redundant Ethernet link.

8. The network device according to claim 2, further comprising a redundancy-system switch for connecting the link switching processor to a selected one of a plurality of redundant Ethernet links which are connected to a same node, wherein when a fault is detected in a currently used one of the redundant Ethernet links, the redundancy-system switch switches the currently used link to another redundant Ethernet link.

9. A method for switching Ethernet links in a network device connecting a plurality of Ethernet links, comprising:
periodically checking whether a link fault occurs on each Ethernet link;
updating link status information for each Ethernet link according to a check result of the Ethernet link; and
switching from a fault-detected Ethernet link to another Ethernet link according to link status information of the Ethernet links.

10. The method according to claim 9, wherein the fault-detected Ethernet link is switched to another Ethernet link by referring to routing information which is updated according to the link status information.

11. The method according to claim 9, wherein both of a first Ethernet link which is a normally used link and a second Ethernet link which is a secondary link are checked, wherein when a fault is detected in the first Ethernet link, a currently used link is switched from the first Ethernet link to the second Ethernet link.

12. The method according to claim 11, wherein the fault-detected Ethernet link is switched to another Ethernet link by referring to routing information which is updated according to the link status information,
wherein both of the first Ethernet link and the second Ethernet link are checked, wherein when a fault is detected in the first Ethernet link, a currently used link is switched from the first Ethernet link to the second Ethernet link.

13. The method according to claim 11, wherein when the first Ethernet link has recovered, a currently used link is switched from the second Ethernet link to the first Ethernet link.

14. The method according to claim 12, wherein when the first Ethernet link has recovered, a currently used link is switched from the second Ethernet link to the first Ethernet link.

15. The method according to claim 9, further comprising:
selecting one of a plurality of redundant Ethernet links which are connected to a same node; and
when a fault is detected in a currently used one of the redundant Ethernet links, switching the currently used link to another redundant Ethernet link.

16. The method according to claim 10, further comprising:
selecting one of a plurality of redundant Ethernet links which are connected to a same node; and
when a fault is detected in a currently used one of the redundant Ethernet links, switching the currently used link to another redundant Ethernet link.

17. A communication system comprising a plurality of network devices, each of which is connected to an adjacent network device through at least one Ethernet link, wherein each of the plurality of network devices comprises:
an Ethernet maintenance and administration section for periodically checking whether a link fault occurs on each Ethernet link;
a link manager for updating link status information for each Ethernet link according to a check result of the Ethernet link; and
a link switching processor for switching from a fault-detected Ethernet link to another Ethernet link according to link status information of the Ethernet links.

18. The communication system according to claim 17, wherein the link switching processor comprises:
a routing table which is updated according to the link status information; and
a routing processor for performing link switching by referring to the routing table.

19. The communication system according to claim 17, wherein the Ethernet maintenance and administration section monitors both of a first Ethernet link which is a normally used link and a second Ethernet link which is a secondary link, wherein when a fault is detected in the first Ethernet link, the link switching processor switches a currently used link from the first Ethernet link to the second Ethernet link.

20. The communication system according to claim 19, wherein the link switching processor comprises:
a routing table which is updated according to the link status information, wherein the a first Ethernet link is determined to be a normally used link and a second Ethernet link to be a secondary link in the routing table; and
a routing processor for performing link switching by referring to the routing table,
wherein the Ethernet maintenance and administration section monitors both of the first Ethernet link and the second Ethernet link, wherein when a fault is detected in the first Ethernet link, the link switching processor switches a currently used link from the first Ethernet link to the second Ethernet link.

21. The communication system according to claim 19, wherein when the first Ethernet link has recovered, the link switching processor switches a currently used link from the second Ethernet link to the first Ethernet link.

22. The communication system according to claim 20, wherein when the first Ethernet link has recovered, the link switching processor switches a currently used link from the second Ethernet link to the first Ethernet link.

23. The communication system according to claim 17, further comprising a redundancy-system switch for connecting the link switching processor to a selected one of a plurality of redundant Ethernet links which are connected to a same node, wherein when a fault is detected in a currently used one of the redundant Ethernet links, the redundancy-system switch switches the currently used link to another redundant Ethernet link.

24. The communication system according to claim 18, further comprising a redundancy-system switch for connecting the link switching processor to a selected one of a plurality of redundant Ethernet links which are connected to a same node, wherein when a fault is detected in a currently used one of the redundant Ethernet links, the redundancy-system switch switches the currently used link to another redundant Ethernet link.

25. A computer-readable program, recorded in a memory, for instructing a program-controlled processor to switch Ethernet links in a network device connecting a plurality of Ethernet links, comprising:
periodically checking whether a link fault occurs on each Ethernet link;
updating link status information for each Ethernet link according to a check result of the Ethernet link; and
switching from a fault-detected Ethernet link to another Ethernet link according to link status information of the Ethernet links.
